(19) United States
(12) Patent Application Publication
(10) Pub. No.: US 2017/0300875 A1
(43) Pub. Date: Oct. 19, 2017

(54) METHOD AND SYSTEM FOR REDUCING POWER CONSUMPTION IN BITCOIN MINING VIA DATA INPUT HOPPING

(71) Applicant: Spondoolies Tech Ltd., Kiryat Gat (IL)

(72) Inventors: Assaf GILBOA, Rehovot (IL); Zvi SHTEINGART, Jerusalem (IL); Kobi LEVIN, Rishon- Le-Zion (IL); Guy COREM, Netanya (IL)

(21) Appl. No.: 15/513,177

(22) PCT Filed: Sep. 21, 2015
(86) PCT No.: PCT/IL2015/050961

§ 371 Date: Mar. 22, 2017

Related U.S. Application Data
(60) Provisional application No. 62/053,834, filed on Sep. 23, 2014.

(51) Int. Cl. G06Q 20/06; G06F 1/32; G06F 9/38; H04L 9/06

(52) U.S. Cl. CPC G06Q 20/065; H04L 9/0643; G06F 1/324; G06F 9/38; H04L 2209/125

(57) ABSTRACT

A method and engine for hash calculation, the method comprising receiving data blocks via an input module, providing clock cycles by a clock module, calculating a hash from a received data block by a process module including a data pipeline and a state pipeline, the hash calculation comprising: receiving an input data block to the data pipeline, calculating, in every other clock cycle of the clock module, an induced data block based on the previous data block, and performing a stage of the state pipeline in each clock cycle of the clock module, in which a state is calculated based on input from the data pipeline, and outputting the hash via an output module.

### FIELD OF THE INVENTION

The present invention relates to implementing bitcoin block chain signing, and more particularly, to implementing same in an efficient engine micro architecture which uses data input hopping technique to support reduced power consumption.

### BACKGROUND OF THE INVENTION

The most important part of the bitcoin system is a public ledger that records financial transactions in bitcoins. This is accomplished without the intermediation of any single, central authority, as long as mining is decentralized. Instead, multiple intermediaries exist in the form of computer servers running bitcoin software. By connecting over the Internet, these servers form a network that anyone can join. Transactions of the form: “payer X wants to send Y bitcoins to payee Z” are broadcast to this network using readily available software applications. Bitcoin servers can validate these transactions, add them to their copy of the ledger, and then broadcast these ledger additions to other servers.

Bitcoin transactions are permanently recorded in a public distributed ledger called the block chain. Approximately six times per hour, a group of accepted transactions, a block, is added to the block chain, which is quickly published to all network nodes. This allows bitcoin software to determine when a particular bitcoin amount has been spent, a novel solution for preventing double-spends in a peer-to-peer environment with no central authority. Whereas a conventional ledger records the transfers of actual bills or promissory notes that exist apart from it, the block chain is the only place that bitcoins can be said to exist. To independently verify the chain-of-ownership of any and every bitcoin amount, full-featured bitcoin software stores its own copy of the block chain.

Maintaining the block chain is referred to as “mining” and those who do are rewarded with newly created bitcoins and transaction fees. Miners may be located anywhere in the world; they process payments by verifying each transaction as valid and adding it to the block chain. Today, payment processing is rewarded with 25 newly created bitcoins per block added to the block chain. To claim the reward, a special transaction called a coinbase is included with the processed payments. All bitcoins in circulation can be traced back to such coinbase transactions. The bitcoin protocol specifies that the reward for adding a block will be halved approximately every four years. Eventually, the reward will be removed entirely when an arbitrary limit of 21 million bitcoins is reached circa 2140, and transaction processing will then be rewarded by transaction fees solely.

Recently, mining has become very competitive, and ever more specialized technology is utilized. The most efficient mining hardware makes use of custom designed application-specific integrated circuits (ASIC), which outperform general purpose CPUs and use less power as well. Without access to these purpose built machines, a bitcoin miner is unlikely to earn enough to even cover the cost of the electricity used in his or her efforts.

Bitcoin block chain consists of transactions that need to be executed that are preceded by header. All the transactions are signed using a Merkle Tree implementation and the signature is embedded in the block header, the block header also needs to be signed by double hash that meets certain conditions in order to become a valid signature that is accepted by the network.

A Merkle tree is a binary tree that is used in bitcoin to summarize all the transactions in a block, producing an overall digital fingerprint of the entire set of transactions. A Merkle tree is constructed by recursively hashing pairs of nodes until there is only one hash, called the root, or Merkle root.

A bitcoin block chain holds the actual transactions and is signed by signing the transactions and the header. The header is the heart of all the bitcoin mining mechanism and is used in order to secure the bitcoin by design as well as driving bitcoin mining efforts.

The mining algorithm for Bitcoins is done by signing the header of each message. Every miner gets a header to sign from a pool which distributes headers to a group of miners. The miner needs to perform the following Hash function in order to find a signature of the header as shown in Equation 1 below:

Signature=SHA-256(SHA-256(Block_Header)) Eq. (1)

The function SHA256 produces a hash with 256 bits. After finding the signature, the miner can know if the header is a valid header and can be sent to the network as a successful transaction. There are very rare cases where the header is valid.

A header is valid only when the signature is smaller than the Target (Bits) in the header. The target is a 256-bit number (extremely large) that all Bitcoin clients share. The SHA-256 hash of a block's header must be lower than or equal to the current target for the block to be accepted by the network. The lower the target, the more difficult it is to generate a block.

The header includes the following fields: version, previous block hash, Merkle root, timestamp, bits and nonce. SHA-256 is calculated over chunks of 512 bits. The block header can be divided to two chunks adding a padding field of 384 b. The first chunk (Chunk 1) includes the version, the previous block hash and a main portion (for example, 224 bits out of 256 bits) of the Merkle root hash. The second chunk (Chunk 2) may include a marginal portion of the Merkle root hash (for example, 32 bits), the timestamp, bits, nonce and the padding field. The version and the padding sections are constant. The previous block hash, the timestamp and the bits sections are changed for each new block header. The Merkle root hash can be changed by the miner within a given header by influencing the Merkle root and the nonce is the dynamic portion which is scanned by the miner in order to look for the signature.

In order to find the header structure that will create a valid signature (less than the target), the miner is allowed to change the 32 b nonce value. The miner can increment the nonce value for every trial and check for a signature, in order to cover all options a 2̂32 trials are needed, which may lead to no resolution and then a new header format should be attempted. (a new header format is created by using a different Merkle root that is extracted from the list of transactions in the message).

In order to focus on the hash algorithm and optimization for the nonce scanning (2̂32 iterations), we will just assume that the miner has an option to change the Merkle root and start a new round of nonce scanning using a new header structure and look for a valid signature again.

As mentioned above, the signature is calculated by applying SHA-256(SHA-256(Header)). The first chunk is hashed first, providing the mid-state hash (H0). H0 is the initial vector (IV) that is used to load the initial state of the SHA of the second chunk which produces that intermediate result of the SHA(Header), This then goes to another SHA function that produces the signature. Therefore, the process involves three SHA iterations (each SHA iteration takes approximately 64 cycles). The mid-state H0 is calculated once per header, usually by the host computer. The next two hashes are the performance calculations and may be carried out by hardware acceleration.

As described above the transactions are signed using a Merkle root hash. The Merkle root can be manipulated by adding a coinbase transaction to the network transactions. As mentioned above, a coinbase transaction belongs to the miner and can be used to get the mining fees.

Power efficiency of the aforementioned double hash architecture plays a critical factor in the engine implementation. In known engine implementations, the engine toggles every clock and the power consumption is split between the logic and the flop flops more or less evenly. The flip flop power is dictated by the shift between stages of the engine. In the known implementations, the shift between stages happens every clock cycle and is a significant contributor to the overall power consumption.

### SUMMARY OF THE INVENTION

Embodiments of the present invention provide a hash engine and method, the engine includes an input module for receiving data blocks, a memory, a clock module to provide clock cycles, a process module including a data pipeline and a state pipeline for calculating a hash from a received data block and an output module to output the hash, the process module is configured to receive an input data block to the data pipeline, calculate, in every other clock cycle of the clock module, an induced data block based on the previous data block and perform a stage of the state pipeline in each clock cycle of the clock module, in which a state is calculated based on input from the data pipeline.

In some embodiments of the present invention, the process module is configured to calculate an induced data block also based on a skipped induced data block.

In some embodiments of the present invention, the process module is configured to use a first word from a data block as an input for calculation of a state of the same clock cycle and a second word from a data block as an input for calculation of a state of the successive clock cycle

In some embodiments of the present invention, the process module is configured to receive to the data pipeline two parallel streams of data blocks and to process them in two parallel sequences of stages, in every other clock cycle. In such embodiments, the process module may further include a multiplexer configured to select in each stage of the state pipeline from which of the two parallel streams of data blocks the input for the state calculation will be taken. The process module may be further configured to use a first word from a data block as an input for calculation of a state of the same clock cycle and a second word from a data block as an input for calculation of a state of the successive clock cycle.

In some embodiments of the present invention, the process module is configured to receive a first input data block in a first clock cycle and a second input data block in the successive clock cycle and to process two respective sequences of stages alternately in each clock cycle. In such embodiments, the process module is configured to use for the state calculation input from the two sequences alternately. the process module may further include a multiplexer configured to select from which sequence the input will be taken.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic illustration of a SHA-256 hash engine according to embodiments of the present invention;

FIG. 2 is a schematic illustration of a state-of-the-art process for signature calculation, also called herein “the regular implementation”;

FIG. 3 is a schematic illustration of a logic circuit diagram representing the logic function that is implemented in order to create an induced data block according to embodiments of the present invention;

FIG. 4 is a schematic illustration of the data shifting in the data pipeline, according to some embodiments of the present invention;

FIG. 5 is a schematic illustration of a process for hash calculation according to some embodiments of the present invention; and

FIG. 6 is a schematic illustration of a method for hash calculation according to some embodiments of the present invention.

The drawings together with the following detailed description make apparent to those skilled in the art how the invention may be embodied in practice.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a system and method for reducing the power consumption in the bitcoin mining process by making the signature calculation process more efficient. According to some embodiments of the present invention, a shift in the Merkle root data, or any data block provided as input to the SHA-256 hash function engine is introduced every two calculation cycles, i.e. every other clock cycle, and therefore the overall power consumption of the Bitcoin mining engine is reduced.

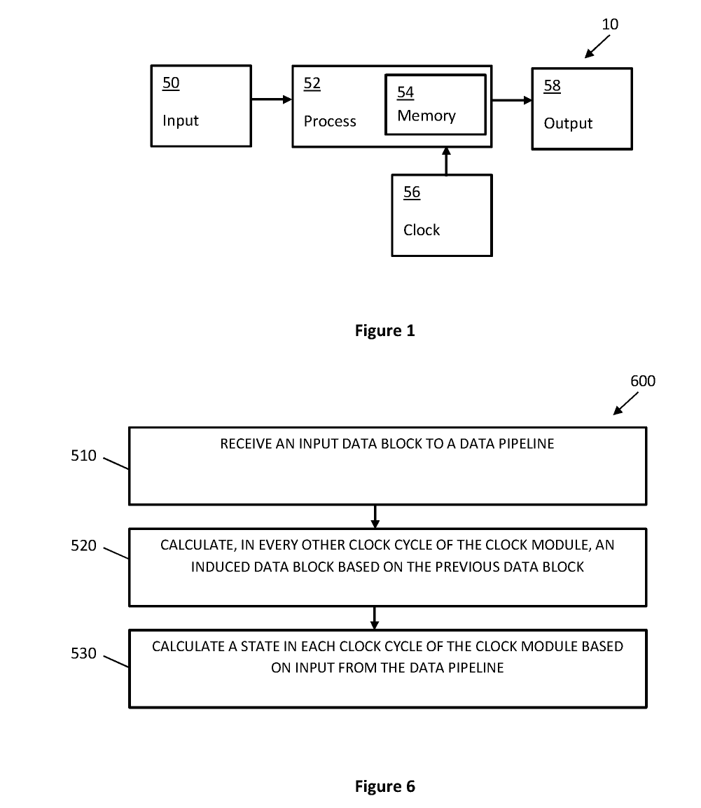

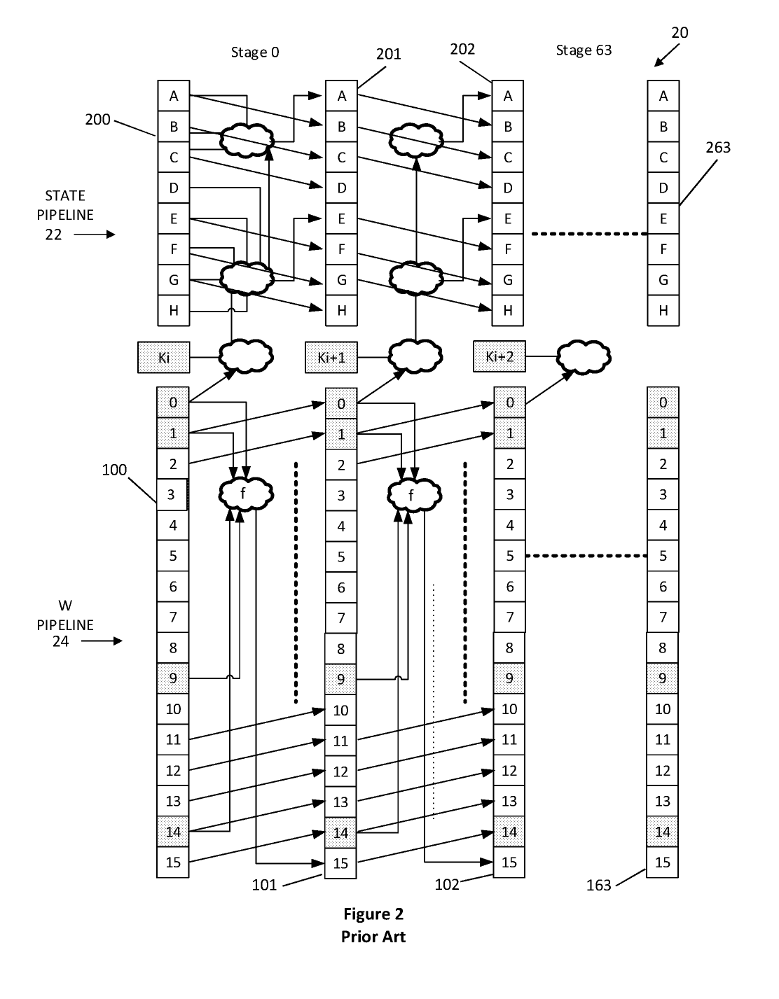

Reference is now made to FIG. 1, which is a schematic illustration of a SHA-256 hash engine 10 in accordance with embodiments of the present invention. Engine 10 includes an input module 50, a process module 52, memory 54, a clock module 56 and an output module 58. As mentioned above, a SHA-256 hash function is used for the signature calculation. In the SHA-256 process, input data block 100 is provided (see more detailed description with reference to FIGS. 2-5) via input module 50. Input data block 100 may be stored in memory 54. Process module 52 may then perform on input data block 100 a SHA-256 hash logic function, which includes an algorithm of 64 repetitive stages, and which produces a signature. The outcome signature may be outputted via output module 58 and/or stored in memory 54. The SHA-256 hash function is performed by a clocked engine, wherein a stage of hash engine 10 is performed in each clock cycle provided by clock module 56. As described in detail herein, embodiments of the present invention enables a shift in the data block every other clock cycle of clock module 56, which enables processing of more data in less power consumption.

Reference is now made to FIG. 2, which is a schematic illustration of a state-of-the-art process 20 for signature calculation, also called herein “the regular implementation”. As mentioned above, a SHA-256 hash function is used for the signature calculation. In the SHA-256 process, input data block 100 is provided, and by a repetitive algorithm of 64 stages that are performed based on input data block 100, a signature 263 is produced. The engine is constructed of a state pipeline 22 and a data (“W”) pipeline 24.

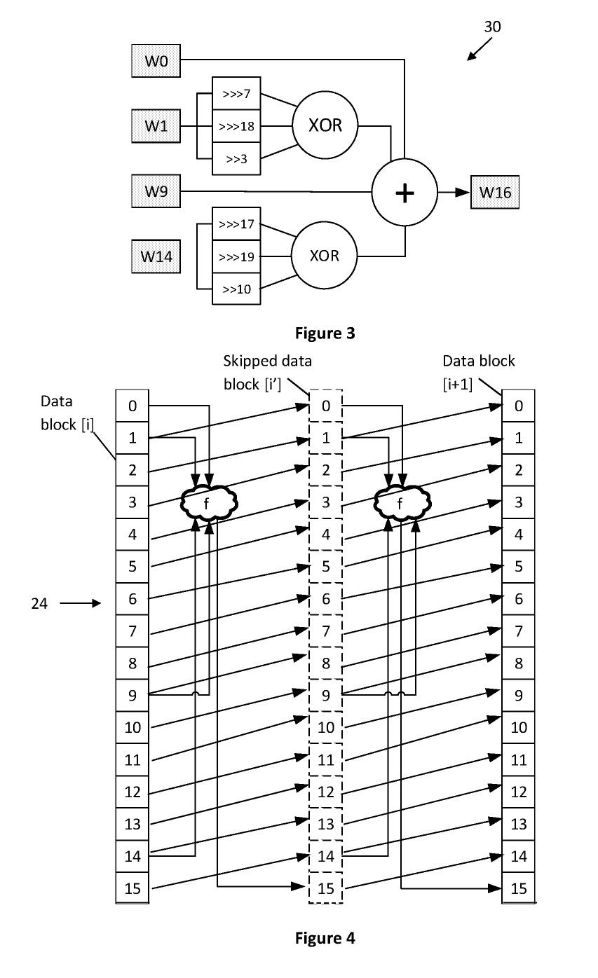

Input data block 100 induces data blocks 101-163, each induced according to a logic algorithm (described in detail with reference to FIG. 3) based on the previous data block. Input data block 100 and each of the induced data blocks 101-163 are 512 bits data blocks, each includes 16 words (“W”s 0-15) of 32 bits. The logic of W pipeline 100 generates an induced data block every stage, by generating a new W15 by a function of words W0, W1, W9 and W14 of the previous data block. That is, W15[i+1]=f(W0[i], W1[i], W9[i], W14[i]). The rest of the words of the induced data block are produced by shifting W1-W15 of the previous block to W0-W14 of the induced block, respectively. Accordingly:

$$W 0 [ i + 1 ] = W 1 [ i ]$$

$$W 1 [ i + 1 ] = W 2 [ i ]$$

$$⋮$$

$$W 14 [ i + 1 ] = W 15 [ i ]$$

Input data block 100 is provided to W pipeline 24, which feeds state pipeline 22 with W0 of input data block 100. A first state 200 is produced based on W0 of input data block 100. Each of the following states 201-263 is produced in the respective stage based on the previous state and on the first word, i.e. W0, of the respective induced data block of the respective stage. For example, a state [i] is produced in stage [i] based on state [i−1] and on W0[i] of data block [i]. Stage [i] gets W0 from data block [i], and the following stage [i+1] get W0[i+1] from data block [i+1].

FIG. 3 is a schematic illustration of a logic circuit diagram representing W15[i+1]=W16[i]=f(W0[i], W1[i], W9[i], W14[i]), i.e. the logic function that is implemented in order to create W15 of an induced data block based on W0, W1, W9 and W14 of the previous data block.

Reference is now made to FIG. 4, which is a schematic illustration of the data shifting in W pipeline 24, according to some embodiments of the present invention. Embodiments of the present invention takes advantage of the fact that since W0[i+1]=W1[i], state pipeline 22 can be fed in two successive stages [i] and [i+1] from the same data block [i], taking W0[i] in stage [i] and W1[i] in stage [i+1]. Therefore, according to embodiments of the present invention, a data hopping may be performed, i.e. the data block of stage [i] may be derived from the data block of stage [i−2]. Therefore, every other stage in W pipeline 24 can be skipped, and an induced data block can be produced and stored in memory 54 once in every two clock cycles. The cost may be an additional, small, logic circuit area but the benefit is the saving of data shift power consumption every other cycle. In other words, W pipeline 24 can run in half frequency while state pipeline 22 can run in full frequency.

According to embodiments of the present invention, a stage may be skipped every other cycle, so that the shift between two data blocks [i] and [i+1] may be done every other cycle. Therefore, W pipeline 24 may process 32 stages instead of 64 stages, for each input data block 100, possibly with the cost of an enlarged logic circuit. State pipeline 22 may still have 64 stages. As shown in FIG. 4, data block [i+1] may be calculated by calculating both transitions, from block [i] to skipped block [i′] (block [i+1] of the regular implementation) and from block [i′] to block [i+1]′ in a single stage. This is a more complicated calculation than the calculation of induced data blocks in the regular 64 stages implementation and therefore in some embodiments of the present invention, for example, an enlarged logic circuit may be required.

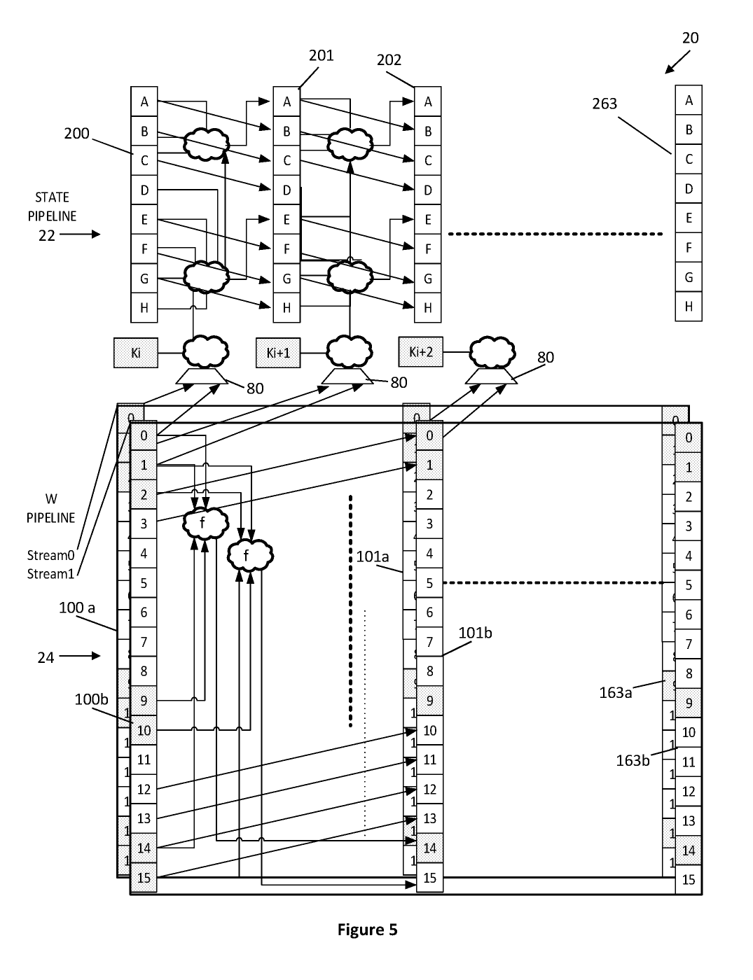

Reference is now made to FIG. 5, which is a schematic illustration of a process 40 for hash calculation according to some embodiments of the present invention. In some embodiments, W pipeline 24 may receive two parallel streams of input data blocks 100a and 100b and process them in two parallel sequences of 32 stages, stream 0 and stream 1. Therefore, a total of 64 calculated stages may be performed in two parallel sequences of 32 stages. The production of induced data in each sequence, blocks 101a-163a in one sequence and blocks 101b-163b in the other sequence, respectively, may be performed according to embodiments of the present invention, for example as described in detail with reference to FIG. 4. In such implementation, the data in W pipeline 24 may shift every other clock. This effectively means that in embodiments of the present invention, W pipeline 24 may run in half the frequency of the regular implementation, and thus, for example, reducing the power consumption significantly. In the state pipeline, the states may still be calculated in each clock cycle, i.e. one state in each of the 64 stages, as described in detail herein above. However, in each stage, a multiplexer 80 may select from which of the two parallel streams of data blocks, stream 0 and stream 1, the input for the state calculation will be taken (W0 or W1 alternately according to whether the stage is odd or even stage). In such embodiment, two input data blocks can be hash together in one process.

It will be appreciated that other embodiments of the present invention may be enabled thanks to the data hopping implementation, while keeping the whole power consumption significantly reduced. For example, if hashing of multiple input data blocks is required, one option is to input a first input data block in a first clock cycle and a second input data block in the successive clock cycle, so that the two sequences of 32 stages are processed alternately (instead of the parallel processing). In this embodiment, for example, the state pipeline may take input from the two sequences alternately, or alternatively, use a multiplexer in order to select from which sequence the input will be taken. It will be appreciated that other embodiments may be enabled by the input data hopping.

Reference is now made to FIG. 6, which is a schematic illustration of a method 500 for hash calculation according to some embodiments of the present invention. As indicated in block 510, the method may include receiving an input data block to a data pipeline, the input data block may include 16 words of 32 bits each. As indicated in block 520, the method may include calculating, in every other clock cycle of the clock module, i.e. in every other stage of the hash engine, an induced data block based on the previous data block. In some embodiments, the calculation is also based on a skipped induced data block. For example, this calculation may include a two-stage calculation in one stage duration, wherein at first a skipped induced data block is calculated and then an induced data block is calculated based on the skipped induced data block. As indicated in block 530, the method may include calculate a state in each clock cycle of the clock module based on input from the data pipeline. That is, using in each clock cycle of the clock module, i.e. in each stage of the hash engine, input from the data pipeline for calculation of a state.

In some embodiments of the present invention, a first word from a data block may be used as an input for calculation of a state of the same stage, e.g. the same clock cycle, and a second word from a data block may be used as an input for calculation of a state of the successive stage, e.g. the successive clock cycle.

In some embodiments of the present invention, the data pipeline may receive two parallel streams of data blocks and process them in two parallel sequences of stages, in every other clock cycle. In such embodiments, a multiplexer may select in each stage of the state pipeline from which of the two parallel streams of data blocks the input for the state calculation will be taken, wherein a first word from a data block may be used as an input for calculation of a state of the same stage, e.g. the same clock cycle, and a second word from a data block may be used as an input for calculation of a state of the successive stage, e.g. the successive clock cycle.

In some embodiments of the present invention, a first input data block is received in a first clock cycle and a second input data block is received in the successive clock cycle, so that the two sequences of stages are processed alternately, i.e. in each clock cycle another of the sequences is processed. In this embodiment, for example, the state pipeline may take input from the two sequences alternately. Alternatively, a multiplexer may be used in order to select from which sequence the input will be taken. It will be appreciated that other embodiments may be enabled by the input data hopping.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claims is:

1. A hash engine comprising:
an input module for receiving data blocks;
a memory;
a clock module to provide clock cycles;
a process module including a data pipeline and a state pipeline for calculating a hash from a received data block, the process module is configured to:
receive an input data block to the data pipeline;
calculate, in every other clock cycle of the clock module, an induced data block based on the previous data block; and
perform a stage of the state pipeline in each clock cycle of the clock module, in which a state is calculated based on input from the data pipeline; and
an output module to output the hash.

2. The hash engine according to claim 1, wherein the process module is configured to calculate an induced data block also based on a skipped induced data block.

3. The hash engine according to claim 1, wherein the process module is configured to use a first word from a data block as an input for calculation of a state of the same clock cycle and a second word from a data block as an input for calculation of a state of the successive clock cycle.

4. The hash engine according to claim 1, wherein the process module is configured to receive to the data pipeline two parallel streams of data blocks and to process them in two parallel sequences of stages, in every other clock cycle.

5. The hash engine according to claim 5, wherein the process module further comprises a multiplexer configured to select in each stage of the state pipeline from which of the two parallel streams of data blocks the input for the state calculation will be taken.

6. The hash engine according to claim 5, wherein the process module is configured to use a first word from a data block as an input for calculation of a state of the same clock cycle and a second word from a data block as an input for calculation of a state of the successive clock cycle.

7. The hash engine according to claim 1, wherein the process module is configured to receive a first input data block in a first clock cycle and a second input data block in the successive clock cycle and to process two respective sequences of stages alternately in each clock cycle.

8. The hash engine according to claim 8, wherein the process module is configured to use for the state calculation input from the two sequences alternately.

9. The hash engine according to claim 8, wherein the process module further comprises a multiplexer configured to select from which sequence the input will be taken.

10. A method for hash calculation, the method comprising:
receiving data blocks via an input module;
providing clock cycles by a clock module;
calculating a hash from a received data block by a process module including a data pipeline and a state pipeline, the hash calculation comprising:
receiving an input data block to the data pipeline;
calculating, in every other clock cycle of the clock module, an induced data block based on the previous data block; and
performing a stage of the state pipeline in each clock cycle of the clock module, in which a state is calculated based on input from the data pipeline; and
outputting the hash via an output module.

11. The method according to claim 10, wherein calculating an induced data block is also based on a skipped induced data block.

12. The method according to claim 10, wherein performing a stage of the state pipeline comprises using a first word from a data block as an input for calculation of a state of the same clock cycle and a second word from a data block as an input for calculation of a state of the successive clock cycle.

13. The method according to claim 10, wherein calculating an induced data block comprises receiving to the data pipeline two parallel streams of data blocks and processing them in two parallel sequences of stages, in every other clock cycle.

14. The method according to claim 13, wherein performing a stage of the state pipeline comprises selecting by a multiplexer in each stage of the state pipeline from which of the two parallel streams of data blocks the input for the state calculation will be taken.

15. The method according to claim 13, wherein performing a stage of the state pipeline comprises using a first word from a data block as an input for calculation of a state of the same clock cycle and a second word from a data block as an input for calculation of a state of the successive clock cycle.

16. The method according to claim 10, wherein calculating an induced data block comprises receiving a first input data block in a first clock cycle and a second input data block in the successive clock cycle and processing two respective sequences of stages alternately in each clock cycle.

17. The method according to claim 16, wherein performing a stage of the state pipeline comprises using for the state calculation input from the two sequences alternately.

18. The method according to claim 16, wherein performing a stage of the state pipeline comprises selecting by a multiplexer from which sequence the input will be taken.
